(19) United States
(12) Patent Application Publication
(10) Pub. No.: US 2012/0283402 A1
(43) Pub. Date: Nov. 8, 2012

(54) Magnesium dichloride-water adducts and catalyst components obtained therefrom

(75) Inventors: Daniele Evangelisti, Ferrara (IT); Benedetta Gaddi, Ferrara (IT); Diego Brita, Ferrara (IT); Gianni Collina, Ferrara (IT); Anna Fait, Ferrara (IT)

(73) Assignee: BASELL POLIOLEFINE ITALIA S.R.L., Milan (IT)

(21) Appl. No.: 13/517,036

(22) PCT Filed: Dec. 17, 2010
(86) PCT No.: PCT/EP2010/070010

§ 371 Date: Jun. 18, 2012

Related U.S. Application Data
(60) Provisional application No. 61/284,680, filed on Dec. 23, 2009.

(30) Foreign Application Priority Data
Jan. 11, 2010 (EP) 10150409.0

(51) Int. Cl. C08F 4/648; C01F 5/30; C08F 4/649; C08F 10/02

(52) U.S. Cl. 526/187; 423/497; 502/125; 502/134

(57) ABSTRACT

Solid adducts comprising MgCl₂ and water and optionally an organic hydroxy compound (A) selected from hydrocarbon structures containing at least one hydroxy group, said compounds being present in molar ratio defined by the following formula MgCl₂.(H₂0)ₙ(A)ₚ in which n is from 0.6 to 6, p ranges from 0 to 3, said adduct having a porosity (P_{F}), measured by the mercury method and due to pores with radius equal to or lower than 1 μm, of at least 0.15 cm³/g with the proviso that when p is 0, (P_{F}) is equal to or higher than 0.3 cm³/g.

This application is the U.S. national phase of International Application PCT/EP2010/070010, filed Dec. 17, 2010, claiming priority to European Application 10150409.0 filed Jan. 11, 2010 and the benefit under 35 U.S.C. 119(e) of U.S. Provisional Application No. 61/284,680, filed Dec. 23, 2009; the disclosures of International Application PCT/EP2010/070010, European Application 10150409.0 and U.S. Provisional Application No. 61/284,680, each as filed, are incorporated herein by reference.

The present invention relates to porous magnesium dichloride/water adducts possibly containing specific amounts of organic hydroxy compounds. The adducts of the present invention are particularly useful as precursors of catalyst components to catalyst components suitable for the preparation of homopolymers and copolymers of ethylene having a broad molecular weight distribution (MWD) and to the catalysts obtained therefrom.

In particular the porous magnesium dichloride/water adducts possibly containing specific amounts of organic hydroxy compounds allow to prepare solid catalyst components, comprising titanium, magnesium and halogen characterized by a specific chemical composition which are suitable to prepare ethylene polymers having a set of properties making them particularly suitable for blow molding applications.

This specific application field is very demanding for ethylene polymers which, in order to be suitable for this use, need to show properties such as broad molecular weight distribution (MWD), proper melt strength/swell balance and ESCR.

The breath of molecular weight distribution (MWD) of the ethylene polymers can be expressed by a high melt flow ratio (F/E) value, which is the ratio between the melt index measured with a 21.6 Kg load (melt index F) and the melt index measured with a 2.16 Kg load (melt index E), determined at 190° C. according to ASTM D-1238. The MWD affects the rheological behavior, the processability of the melt and also the final ESCR properties. Polyolefin having a broad MWD, particularly coupled with relatively high average molecular weight, are preferred in high speed extrusion processing where polymers having a not proper MWD could cause melt fracture and higher shrinkage/warpage of the final items. However, it has been proven to be a very difficult task to obtain polymers combining broad MWD with a proper melt strength/swell balance. This is because MWD also affects melt strength and swell in a different way.

It would also be advisable that the catalyst is capable to work successfully under gas-phase polymerization conditions, as this kind of technique is nowadays the most effective, advantageous and reliable technology. This means that the catalyst needs to have a good morphological stability preventing its improper fragmentation and consequent formation of fines particle responsible of plant operation problems such as, hot spots, reactor sheeting, plugging etc.

MgCl₂.alcohol adducts and their use in the preparation of catalyst components for the polymerization of olefins is well known in the art.

Catalyst components for the polymerization of olefins, obtained by reacting MgCl₂.nEtOH adducts with halogenated transition metal compounds, are described for example in U.S. Pat. No. 4,399,054. The adducts are prepared by emulsifying the molten adduct in an immiscible dispersing medium and quenching the emulsion in a cooling fluid to collect the adduct in the form of spherical particles. In order to produce a catalytic components a transition metal compound must be fixed on the support. This is obtained by contacting the supports with large amounts of titanium compounds, in particular TiCl₄, that causes removal of the alcohol and supportation of Ti atoms. The so obtained catalysts show very high activities but their morphological stability is not always satisfactory because, under polymerization conditions, it often gives rise to a non negligible amount of broken polymer particle that contribute to generate the fine polymer particles which negatively affect the operation of the polymerization plant.

U.S. Pat. No. 3,953,414 describes catalyst components having good morphological stability obtained by (i) spraying a hydrated Mg dihalide in the molten state or dissolved in water, and more particularly molten MgCl₂.6H₂O having sizes comprised in general between 1 and 300 micron, preferably 30 to 180 micron; (ii) subsequently subjecting said particles to a controlled partial dehydration to bring the crystallization water content to a value below 4 moles of H₂O per mole of the Mg dihalide while avoiding hydrolysis of the Mg dihalide; thereafter (iii) reacting the partially dehydrated Mg dihalide particles in a liquid medium comprising a halogenated Ti compound, more particularly TiCl₄, heated to a temperature generally higher than 100° C., and (iv) finally removing the unreacted Ti compound from the Mg dihalide particles, by further reaction with hot TiCl₄. The document does not indicate whether the catalyst is suitable to produce broad MWD polymers or whether such polymers are suitable for blow molding. However, it is apparent that the polymerization activity is not sufficient.

The applicant has now found that certain porous magnesium chloride/water based adducts possibly containing additional amounts of organic hydroxy compounds, are able to generate catalyst components with high polymerization activity and enhanced morphological stability suitable to prepare ethylene polymers having a set of properties making them particularly suitable for blow molding applications.

The present invention therefore relates to solid adducts comprising MgCl₂ and water and optionally an organic hydroxy compound (A) selected from hydrocarbon structures containing at least one hydroxy group, said compounds being present in molar ratio defined by the following formula MgCl₂.(H₂0)ₙ(A)ₚ in which n is from 0.6 to 6, p ranges from 0 to 3, said adduct having a porosity (P_{F}), measured by the mercury method and due to pores with radius equal to or lower than 1 μm, of at least 0.15 cm³/g with the proviso that when p is 0, (P_{F}) is equal to or higher than 0.3 cm³/g.

When p is 0, n preferably ranges from 0.7 to 5.5, more preferably from 0.7 to 4 and especially from 1 to 3.5 with the range from 1 to 3 being the most preferred. The porosity preferably ranges from 0.35 to 1.5 and more preferably from 0.4 to 1 cm³/g.

When p is higher than 0, it preferably ranges from 0.1 to 2.5 and preferably from 0.3 to 2 cm³/g, while n ranges from 0.6 to 2 preferably from 0.8 to 1.5 and the porosity preferably ranges from 0.15 to 0.6 cm³/g.

The compound (A) may also contain two or more hydroxy groups. It can be selected either from unsaturated or saturated hydrocarbon structures. Example of such polyhydroxy compounds are glycols, polyhydroxybenzenes, polyhydroxy naphthalenes.

Preferably, the compound (A) is selected from alcohols of formula R^{II}OH where preferably selected from R^{II} is an alkyl, cycloalkyl or aryl radical having 1-12 carbon atoms. Among them, Methyl, ethyl, isopropyl and cyclohexyl are preferred. Ethyl is especially preferred. Particularly when the compound (A) is selected from alcohols, the ratio n/p is preferably equal to or higher than 0.4. More preferably, such a ratio is in combination with the sum n+p being at least 1 and even more preferably higher than 1.5.

The adducts of the invention can be obtained by hydration of porous MgCl₂ which is in turn obtained by thermally dealcoholating MgCl₂nEtOH adducts in which n is from 1 to 6.

Adducts of this type can generally be obtained by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. Representative methods for the preparation of these spherical adducts are reported for example in U.S. Pat. No. 4,469,648, U.S. Pat. No. 4,399,054, and WO98/44009. Another useable method for the spherulization is the spray cooling described for example in U.S. Pat. Nos. 5,100,849 and 4,829,034. The so obtained adducts are then subject to a thermal and/or chemical dealcoholation process. The thermal dealcoholation process is carried out in nitrogen flow at temperatures comprised between 50 and 150° C. until the alcohol is totally removed or reduced to a sufficiently low value. A process of this type is described in EP 395083 and leads to the achievement of porous MgCl₂ optionally containing residual amounts of alcohol. According to the preferred process of the present invention the porous MgCl₂ is subject to a hydration process in which the desired amount of water is gradually added to the adducts. The hydration can be carried out in several ways. For example the porous MgCl₂ can be suspended in an inert liquid hydrocarbon containing water and kept in motion until the desired water/Mg ratio is obtained. After that, the liquid phase can be removed and the solid adduct dried under moderate vacuum.

According to another method water can be sprayed in a chamber or a loop reactor within which the porous MgCl₂ is kept in continuous motion, through mechanical stirring or inert gas fluidization. At the end of the water adduction the hydrated adduct is recovered via the usual means.

By way of these methods, it is possible to obtain final hydrated adducts particles in spherical or spheroidal form. Such spherical particles have a ratio between maximum and minimum diameter lower than 1.5 and preferably lower than 1.3.

The adduct of the invention can be obtained in a broad range of particle size, namely ranging from 5 to 150 microns preferably from 10 to 100 microns and more preferably from 15 to 80 microns. Surprisingly, it has been found that said adducts have a porosity higher than that of the adducts in which the water is replaced by a corresponding amount of another donor, in particular an alcohol.

The adducts of the invention are converted into catalyst components for the polymerization of olefins by reacting them with a transition metal compound of one of the groups IV to VI of the Periodic Table of Elements.

Among transition metal compounds particularly preferred are titanium compounds of formula Ti(OR)ₙX_{y-n} in which n is comprised between 0 and y; y is the valence of titanium; X is halogen and R is an alkyl radical having 1-8 carbon atoms or a COR group. Among them, particularly preferred are titanium compounds having at least one Ti-halogen bond such as titanium tetrahalides or halogenalcoholates. Preferred specific titanium compounds are TiCl₃, TiCl₄, Ti(OBu)₄, Ti(OBu)Cl₃, Ti(OBu)₂Cl₂, Ti(OBu)₃Cl. Preferably the reaction is carried out by suspending the adduct in cold TiCl₄ (generally 0° C.); then the so obtained mixture is heated up to 80-130° C. and kept at this temperature for 0.5-2 hours. After that the excess of TiCl₄ is removed and the solid component is recovered. The treatment with TiCl₄ can be carried out one or more times. As a result of the reaction, part of the Ti atoms can remained fixed on the catalyst as TiOCl₂.

The reaction between transition metal compound and the adduct can also be carried out in the presence of an electron donor compound (internal donor) in particular when the preparation of a stereospecific catalyst for the polymerization of olefins is to be prepared. Said electron donor compound can be selected from esters, ethers, amines, silanes and ketones. In particular, the alkyl and aryl esters of mono or polycarboxylic acids such as for example esters of benzoic, phthalic, malonic and succinic acid are preferred.

The electron donor compound is generally present in molar ratio with respect to the magnesium comprised between 1:4 and 1:20.

Preferably, the particles of the solid catalyst components have substantially the same size and morphology as the adducts of the invention generally comprised between 5 and 150 μm. The solid catalyst components according to the present invention show a surface area (by B.E.T. method) generally between 10 and 500 m²/g and preferably between 20 and 350 m²/g, and a total porosity (by B.E.T. method) higher than 0.15 cm³/g preferably between 0.2 and 0.6 cm³/g.

The amount of titanium atoms is preferably higher than 4.5% more preferably higher than 5.5% and especially higher than 7% wt. According to a preferred embodiment more than 80% of the titanium atoms are in a +4 valence state and, more preferably, substantially all the titanium atoms are in such a valence state. Throughout the present application the wording “substantially all the titanium atoms are in valence state of 4” means that at least 95% of the Ti atoms have a valence state of 4.

The catalyst of the present invention may show also another additional interesting feature. The amount of total anions that are detected, according to the below reported methods, on the solid catalyst component are usually not enough to satisfy the total of positive valences deriving from the cations including, but not limited to, Mg, Ti even taking into account the possible presence of OR groups. In other words, it has been noticed that in the catalyst of the invention a certain amount of anions is often lacking in order to have all the valences of the cations satisfied. According to the present invention, this lacking amount is defined as “LA” factor where “LA” factor is the molar equivalent of anionic species lacking in order to satisfy all the molar equivalents of the cations present in the solid catalyst component which have not been satisfied by the total molar equivalent of the anions present in the solid catalyst component, all of the molar equivalents of anions and cations being referred to the Ti molar amount.

The LA factor is determined by first determining the molar contents of all the anions and cations detected by the analysis. Then, the molar content relative to all of the anions (including but not limited to Cl⁻ and —OR) and cations (including but not limited to Mg, and Ti) is referred to Ti by dividing it for the Ti molar amount which is therefore considered as the molar unity. Afterwards, the total number of molar equivalents of cations to be satisfied is calculated for example by multiplying the molar amount of Mg⁺⁺ (referred to Ti) by two and the molar amount of Ti⁺⁴ (molar unity) by four. The so obtained total value is then compared with the sum of the molar equivalents deriving from anions, for example Cl and OR groups, always referred to titanium. The difference resulting from this comparison, and in particular the negative balance obtained in terms of anion molar equivalents, indicates the LA factor.

The “LA” factor is usually higher than 0.5, preferably higher than 1 and more preferably in the range from 1.5-6.

The catalyst components of the invention form catalysts for the polymerization of alpha-olefins CH₂═CHR, wherein R is hydrogen or a hydrocarbon radical having 1-12 carbon atoms, by reaction with organo-Al compounds. Among them preferred are hydrocarbyl compound of the formula AlR_{3-z}X_{z} above, in which R is a C1-C15 hydrocarbon alkyl or alkenyl radical, X is halogen preferably chlorine and z is a number 0≦z<3. The organo-Al compound is preferably chosen among the trialkyl aluminum and trialkenyl compounds such as for example trimethylaluminum triethylaluminum, triisobutylaluminum, tri-n-butylaluminum, tri-n-hexylaluminum, tri-n-octylaluminum, triisoprenylaluminum. It is also possible to use alkylaluminum halides, alkylaluminum hydrides or alkylaluminum sesquichlorides such as AlEt₂Cl and Al₂Et₃Cl₃ optionally in mixture with said trialkyl aluminum compounds.

The Al/Ti ratio is higher than 1 and is generally comprised between 20 and 2000, preferably from 20 to 800.

It is possible to use in the polymerization system an electron donor compound (external donor) which can be the same or different from the compound that can be used as internal donor disclosed above. The external donor is preferably selected from those of the following formula

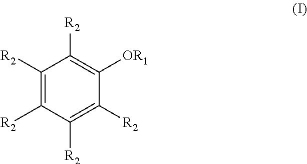

wherein:

R₂, equal to or different from each other, are hydrogen atoms or C₁-C₂₀ hydrocarbon radicals optionally containing heteroatoms belonging to groups 13-17 of the periodic table of the elements or alkoxy groups of formula —OR₁, two or more of the R₂ groups can be connected together to form a cycle; R₁ are C₁-C₂₀ hydrocarbon radicals optionally containing heteroatoms belonging to groups 13-17 of the periodic table of the elements.

Preferably, at least one of R₂ is −OR₁.

In general, it is preferred that the two —OR₁ groups are in ortho position to each other.

Accordingly, 1,2-dialkoxybenenes, 2,3-alkyldialkoxybenzenes or 3,4-alkyldialkoxybenzenes are preferred. The other R₂ groups are preferably selected from hydrogen, C1-05 alkyl groups and OR₁ groups. When two R₂ are alkoxygroup OR₁, a trialkoxybenzene derivative is obtained and in this case the third alkoxy may be vicinal (ortho) to the other two alkoxy or in meta position with respect to the closest alkoxygroup. Preferably, R₁ is selected from C₁-C₁₀ alkyl groups and more preferably from C1-05 linear or branched alkyl groups. Linear alkyls are preferred. Preferred alkyls are methyl, ethyl, n-propyl, n-butyl and n-pentyl.

When one or more of the R₂ is a C1-05 linear or branched alkyl groups, alkyl-alkoxybenzenes are obtained. Preferably, R₂ is selected from methyl or ethyl. According to a preferred embodiment one of the R₂ is methyl.

One of the preferred subclasses is that of the dialkoxytoluenes, among this class preferred members are 2,3-dimethoxytoluene, 3,4-dimethoxytoluene, 3,4-diethoxytoluene, 3,4,5 trimethoxytoluene.

It has to be noted that, with respect to the hydrated adducts of the prior art the adducts of the invention are capable to give catalyst components showing higher polymerization activity at the same level of morphological stability.

As previously indicated the components of the invention and catalysts obtained therefrom find applications in the processes for the (co)polymerization of olefins of formula CH₂═CHR in which R is hydrogen or a hydrocarbon radical having 1-12 carbon atoms.

The spherical components of the invention and catalysts obtained therefrom find applications in the processes for the preparation of several types of olefin polymers.

For example the following can be prepared: high density ethylene polymers (HDPE, having a density higher than 0.940 g/cm³), comprising ethylene homopolymers and copolymers of ethylene with alpha-olefins having 3-12 carbon atoms; linear low density polyethylene's (LLDPE, having a density lower than 0.940 g/cm³) and very low density and ultra low density (VLDPE and ULDPE, having a density lower than 0.920 g/cm³, to 0.880 g/cm³ cc) consisting of copolymers of ethylene with one or more alpha-olefins having from 3 to 12 carbon atoms, having a mole content of units derived from the ethylene higher than 80%; elastomeric copolymers of ethylene and propylene and elastomeric terpolymers of ethylene and propylene with smaller proportions of a diene having a content by weight of units derived from the ethylene comprised between about 30 and 70%, isotactic polypropylenes and crystalline copolymers of propylene and ethylene and/or other alpha-olefins having a content of units derived from propylene higher than 85% by weight; shock resistant polymers of propylene obtained by sequential polymerization of propylene and mixtures of propylene with ethylene, containing up to 30% by weight of ethylene; copolymers of propylene and 1-butene having a number of units derived from 1-butene comprised between 10 and 40% by weight.

However, as previously indicated they are particularly suited for the preparation of broad MWD polymers and in particular of broad MWD ethylene homopolymers and copolymers containing up to 20% by moles of higher α-olefins such as propylene, 1-butene, 1-hexene, 1-octene.

In particular the catalysts of the invention are able to give ethylene polymers, in a single polymerization step, with a broad molecular weight distribution as evidenced by the high ratio of the F/E ratio, defined as mentioned above, and also endowed with a suitable set of properties for the blow molding application.

The catalysts of the invention can be used in any kind of polymerization process both in liquid and gas-phase processes. Catalysts in which the solid catalyst component has small average particle size, such as less than 30 μm, preferably ranging from 5 to 20 μm, are particularly suited for slurry polymerization in an inert medium, which can be carried out continuously stirred tank reactor or in loop reactors. In a preferred embodiment the solid catalyst components having small average particle size as described are particularly suited for the use in two or more cascade loop or stirred tank reactors producing polymers with different molecular weight and/or different composition in each reactor. Catalysts in which the solid catalyst component has medium/large average particle size such as at least 30 μm and preferably ranging from 50 to 100 μm are particularly suited for gas-phase polymerization processes which can be carried out in agitated or fluidized bed gas-phase reactors.

The following examples are given to further illustrate without limiting in any way the invention itself.

### Characterization

The properties reported below have been determined according to the following methods:
Porosity and surface area with nitrogen: are determined according to the B.E.T. method (apparatus used SORPTOMATIC 1900 by Carlo Erba).
   Porosity and surface area with mercury:
   The measure is carried out using a “Porosimeter 2000 series” by Carlo Erba.
   The porosity is determined by absorption of mercury under pressure. For this determination use is made of a calibrated dilatometer (diameter 3 mm) CD₃ (Carlo Erba) connected to a reservoir of mercury and to a high-vacuum pump (1·10⁻² mbar). A weighed amount of sample is placed in the dilatometer. The apparatus is then placed under high vacuum (<0.1 mm Hg) and is maintained in these conditions for 20 minutes. The dilatometer is then connected to the mercury reservoir and the mercury is allowed to flow slowly into it until it reaches the level marked on the dilatometer at a height of 10 cm. The valve that connects the dilatometer to the vacuum pump is closed and then the mercury pressure is gradually increased with nitrogen up to 140 kg/cm². Under the effect of the pressure, the mercury enters the pores and the level goes down according to the porosity of the material.
   The porosity (cm³/g), both total and that due to pores up to 1 μm, the pore distribution curve, and the average pore size are directly calculated from the integral pore distribution curve which is function of the volume reduction of the mercury and applied pressure values (all these data are provided and elaborated by the porosimeter associated computer which is equipped with a “MILESTONE 200/2.04” program by C. Erba.
   MIE flow index: ASTM-D 1238
   MIF flow index: ASTM-D 1238
   Bulk density: DM-53194
   Effective density: ASTM-D 792

### EXAMPLES

### Example 1

### MgCl₂ Bi-Hydrate Complex

A sample of spherical magnesium chloride bi-hydrate complex was prepared according the following method. For the test a starting microspheroidal MgCl₂.2.8C₂H₅OH was used, prepared according to the method described in ex.2 of WO98/44009 but operating on larger scale and under stirring conditions so as to have an average size of 69.5 μm. The said adduct was then subject to thermal dealcoholation at increasing temperatures from 30 to 130° C. and operating in nitrogen current until a chemical composition of 45.1% wt. ethanol, 1.7% wt. water, 53.2% magnesium chloride was reached. Once obtained, 5949 g of this material were loaded into a 150 mm diameter glass jacketed fluidized bed reactor equipped with dedicated heating systems for both fluidization nitrogen and for the reactor main body, processed with nitrogen flow rate kept at 1200 l/h providing a good fluidization, and then warmed up from 60° C. to 110° C. in 3 hrs, and kept at 110° C. for an extra hour. After that time (at a new composition of about 40% ethanol by weight) a calibrated amount of water (1198 g) was added to the reactor by a volumetric peristaltic pump, operating at a feed rate of about 100 ml/h. The water was fed directly into the fluidizing (jacketed) nitrogen line, warmed up to 104-106° C. and then introduced to the fluidized reactor. The moist nitrogen stream temperature was measured just below the fluidizing grid, operating between 85° C. and 94° C., and recorded. After about 11.5 hrs of continuous water feeding into the reactor the total desired amount of water was fed, while ethanol was removed out of the reactor by the fluidizing nitrogen. Part of the condensed ethanol (520 ml) was collected and recovered in the cyclones section of the nitrogen line after the reactor (no fines or solid is found in the cyclones at the chosen fluidization conditions). After completion of water adduction, the support is cooled down to room temperature and discharged (4212 grams, corresponding to a yield/recovery in magnesium of 96.9% compared to the theoretical expected weight). Chemical analyses showed a residual 0.3% ethanol content by weight, 27.3% wt. of water, 18% of elemental magnesium. The final adduct showed a porosity of 0.83 cm³/g

### Example 2

### 0.48EtOH.1.15H₂O.MgCl₂ Complex Preparation

A micro sample of spherical mixed MgCl₂0.48*EtOH.1.15H₂O. complex was prepared according to the following method. For the test a starting microspheroidal MgCl₂.2.8C₂H5OH was used, prepared as described in example 1 with the only difference that the stirring conditions were adjusted so as to obtain a solid adduct having an average size of 45.6 μm. The said adduct was then subject to thermal dealcoholation at increasing temperatures from 30 to 130° C. and operating in nitrogen current until a chemical composition of EtOH=24.2% wt, H₂O=3.2% wt. magnesium chloride=72.6 wt. was reached. The support obtained (500 g) was loaded into a 65 mm diameter glass jacketed fluidized bed reactor equipped with dedicated heating systems for both fluidization nitrogen and for the reactor main body, fluidized with nitrogen at 1300 l/h providing a good fluidization and warmed up from room temperature to 40° C. in few minutes, and then kept at 40° C. for a total reaction time of 9 hours. After warming-up time, a calibrated amount of water (75 g) was slowly added to the reactor by a precise volumetric peristaltic pump, operating at a feed rate of about 0.14 ml/min. The water was fed directly into the fluidizing (jacketed) nitrogen line, warmed up to 46-48° C. and then introduced to the fluidized reactor as water vapor. The moist nitrogen stream temperature was measured just below the fluidizing grid, operating between 40-41° C., and recorded. After about 9 hrs of continuous water feeding into the reactor the total desired amount of water was fed. Nitrogen flow was progressively reduced from 1300 down to 700 l/h to prevent mass loss. After completion of water adduction, the support is cooled down to room temperature and discharged (490 g). Chemical analyses showed 17.4% Mg, 14.8% water, 15.7% EtOH and corresponding to a complex of the following composition: 0.48 EtOH.1.15H₂O.MgCl₂. The final adduct showed a porosity of 0.52 cm³/g

### Example 3

### 1.17EtOH.1.02H₂O.MgCl₂ Complex Preparation

A sample of spherical mixed 1.17*EtOH.1.02*H₂O.MgCl₂ complex was prepared according to the following method. For the test a starting microspheroidal MgCl₂.2.8C₂H₅OH was used, prepared as described in example 1 with the only difference that the stirring conditions were adjusted so as to obtain a solid adduct having an average size of 73.4 μm. The so obtained adduct, was then subject to thermal dealcoholation at increasing temperatures from 30 to 130° C. and operating in nitrogen current until a chemical composition of EtOH=45.6% wt, H₂O=1.3% wt. magnesium chloride=53% wt. was reached. Once obtained, 500 g of this material were loaded into a 65 mm diameter glass jacketed fluidized bed reactor equipped with dedicated heating systems for both fluidization nitrogen and for the reactor main body, fluidized at 1080 l/h providing a good fluidization, and warmed up from room temperature to 45° C. in few minutes. After warming-up time, a calibrated amount of water (58 g) was slowly added to the reactor by a precise volumetric peristaltic pump, operating at a feed rate of about 0.14 ml/min (8.5 ml/h) and kept at 45° C. for a total reaction time of about 7 hours. The water was fed directly into the fluidizing (jacketed) nitrogen line, warmed up to 52-53° C. and then introduced to the fluidized reactor as water vapor. The moist nitrogen stream temperature was measured just below the fluidizing grid, operating at 45° C., and recorded. After about 7 hrs of continuous water feeding into the reactor the total desired amount of water was fed. Nitrogen flow was kept at 1080 l/h for the whole duration of the trial. After completion of water adduction, the support is cooled down to room temperature and discharged (440 g). Chemical analyses showed 14.3% Mg, 10.8% water, 31.7% ethanol, corresponding to a complex of the formula 1.17EtOH.1.02H₂O.MgCl₂ complex. The final adduct showed a porosity of 0.32 cm³/g

### Example 4

### 1.07H₂O.MgCl₂ Complex Preparation

A sample of spherical 1.07H₂O.MgCl₂ complex was prepared according to the following method. For the test a starting microspheroidal MgCl₂.2.8C₂H₅OH was used, prepared as described in example 1 with the only difference that the stirring conditions were adjusted so as to obtain a solid adduct having an average size of 44 μm. The so obtained adduct was then subject to thermal dealcoholation at increasing temperatures from 30 to 130° C. and operating in nitrogen current until a chemical composition of EtOH=24.2% wt, H₂O=1.6% wt., magnesium chloride 74.2% wt. was reached. Once obtained, 500 g of this material were loaded into a 65 mm glass jacketed fluidized bed reactor as described in Example 2, were first fluidized using nitrogen at a feed rate of 600 l/h and then gradually lowering to 360 l/h in the second part of the preparation, always providing a good fluidization; the spherical support was warmed up from room temperature to 120° C. in 30 minutes, and then kept at 120° C. for 2 hrs., then 130° C. for 2 hrs., and finally 135° C. for 4 hrs, while the nitrogen was warmed up by a heating system operated at the same temperature, achieving a warming up the gas to 72-78° C. under reactor grid. After warming-up time, a calibrated amount of water (68 g) was slowly added to the reactor by a precise volumetric peristaltic pump, operating at a feed rate of about 0.19 ml/min for 6 hrs. The water was fed directly into the fluidizing (jacketed) nitrogen line, warmed up to 72-78° C. and then introduced to the fluidized reactor as water vapor. After about 6 hrs of continuous water feeding into the reactor plus and extra equilibration processing time of 2 hrs (with no water supply), the total desired amount of water was fed. After completion of water adduction, the support is cooled down to room temperature and discharged (406 g). Chemical analyses showed 21.7% Mg, 17.2% water, corresponding to a complex of formula 1.07H₂O.MgCl₂ which also showed a porosity of 0.746 cm³/g.

### Example 5

### 5.91H₂O.MgCl₂ Complex Preparation

A sample of spherical 5.91*H₂O.MgCl₂ complex was prepared in a rotavapor, which was employed as flowing/rolling-bed reactor. The flask was loaded with 100 g of bi-hydrate MgCl₂ complex prepared as described in example 1. The flask was then attached to the rotavapor and the support was thus allowed to roll into the flask, while external moist air was continuously circulated into the flask of rolling support, carrying along small amounts of water vapor. The water was thus supplied in a continuous way, resulting in a progressive weight increase of the flask & support gross weight. After 120 hours of rolling, 156 g of spherical material were collected, having a composition of 5.91H₂O.MgCl₂ and a porosity of 0.369 cm³/g.

### Example 6

### 3.57H₂O.MgCl₂ Complex Preparation

A sample of spherical 3.57H₂O.MgCl₂ complex was prepared in a rotavapor used as flowing/rolling bed reactor as above.

Hydration was followed by measuring weight increase as above. After 12 h of rolling, 100 g of bi-hydrate MgCl₂ complex prepared as described in example 1 were transformed into 113.2 g of a spherical support, having a composition of 3.6H₂O.MgCl₂ having porosity of 0.533 cm³/g.

### Comparative Example 7

A sample of spherical 2*H₂O.MgCl₂ complex was prepared by dehydration in an oven of an adduct MgCl₂.6H₂O prepared according to Example 1 of U.S. Pat. No. 3,953,414. The porosity determination gave a result of 0.21 cm³/g.

### Comparative Example 8

A magnesium chloride and alcohol adduct was prepared following the method described in example 2 of U.S. Pat. No. 4,399,054, but working at 2000 RPM instead of 10000 RPM. The adduct containing about 3 mols of alcohol and 3.1% wt of H₂O and had an average size of about 70 μm. The adduct were subject to a thermal treatment, under nitrogen stream, over a temperature range of 50-150° C. until an adduct having formula 0.8*EtOH.0.2*H₂O.MgCl₂ was reached.

### Example 8

### Preparation of the Solid Component

Catalysts were prepared starting from the different MgCl₂ based complexes as obtained in the examples 1-6 and comparative example 8 according to the following general procedure.

Into a 2 l glassware reactor provided with a stirrer, 1.0 L of TiCl₄ at 0° C. and the amount of spherical support needed to get a total Lewis Base concentration of 0.8 mol/L were gently introduced. The whole was heated to 135° C. over 150 minutes and these conditions were maintained for a further 4.5 h. The stirring was interrupted and after 30 minutes the liquid phase was separated from the solid. Thereafter 6 washings with anhydrous hexane (1.01) were performed two of which were carried out at 60° C. and four at room temperature. After drying under vacuum at about 50° C., a free flowing solid was recovered and analyzed. Catalyst characteristics are reported in Table 1.

### Example 9

### Preparation of the Solid Component

Catalysts were prepared starting from the different MgCl₂ based complexes as obtained in the examples 1-6 and comparative example 8 according to the following general procedure.

Into a 2 l glassware reactor provided with a stirrer, 1.0 L of TiCl₄ at 0° C. and the amount of spherical support needed to get a total Lewis Base concentration of 0.8 mol/L were gently introduced. The whole was heated to 135° C. over 150 minutes and these conditions were maintained for a further 4.5 h. The stirring was interrupted and after 30 minutes the liquid phase was separated from the solid.

Fresh TiCl₄ (1.0 L) was loaded into the reactor and the resulting slurry was warmed to 130° C. for one hour. Then, the stirring was stopped and after 30 minutes, the liquid phase was drawn off. Thereafter 6 washings with anhydrous hexane (1.0 L) were performed two of which were carried out at 60° C. and four at room temperature. After drying under vacuum at about 50° C., a free flowing solid was recovered and analyzed. Catalyst characteristics are reported in Table 1.

TABLE 1
Catalysts preparation and compositions

| Support | Catalyst | | | | | |
|---|---|---|---|---|---|---|
| Prepared as | Prepared as | | | | | |
| Described in | Described in | Ti | Mg | Cl | EtOH | Solvent |
| Ex.# | Ex.# | Wt % | Wt % | Wt % | Wt % | Wt % |
| 1 | 8 | 10.8 | 16.6 | 63.4 | <0.1 | 1.7 |
| 1 | 9 | 4.9 | 20.3 | 70.1 | <0.1 | 1.3 |
| 2 | 8 | 11.0 | 15.4 | 61.2 | <0.1 | 3.5 |
| 2 | 9 | 5.9 | 18.9 | 70.4 | <0.1 | 1.9 |
| 3 | 8 | 12.6 | 13.3 | 59.9 | <0.1 | 7.8 |
| 3 | 9 | 7.4 | 16.4 | 65.0 | <0.1 | 5.7 |
| 4 | 8 | 6.4 | 20.6 | 67.7 | <0.1 | 0.6 |
| 4 | 9 | 2.6 | 22.8 | 71.2 | <0.1 | 0.4 |
| 5 | 8 | 18.8 | 10.1 | 55.8 | <0.1 | 3.9 |
| 5 | 9 | 7.0 | 17.9 | 65.4 | <0.1 | 3.3 |
| 6 | 8 | 15.8 | 12.3 | 59.6 | <0.1 | 3.7 |
| Comp. 8 | 8 | 7.6 | 17.7 | 66.6 | <0.1 | 1.9 |

### Example 11

### Low Melt Index Slurry Phase Ethylene Polymerization (HDPE): General Procedure

The whole set of catalysts obtained as described in the previous examples were tested in ethylene polymerization experiments according to the following procedure.

Into a 4 liters stainless steel autoclave, degassed under N₂ stream at 70° C., 1600 cc of anhydrous hexane, 0.08 g of spherical catalyst and 0.3 g of triisobutylaluminum (Tiba) were introduced. The whole was stirred, heated to 75° C. and thereafter 7 bar of H₂ and 7 bar of C₂H₄ were fed. The polymerization lasted 2 hours feeding ethylene to keep the pressure constant. At the end, the reactor was depressurised and the temperature was dropped to 30° C. The collected polymer was dried at 70° C. under a nitrogen flow. The obtained resulted are showed in Table 2.

### Example 12

### High Melt Index Slurry Phase Ethylene Polymerization (HDPE): General Procedure

The whole set of catalysts obtained as described in the previous examples were tested in ethylene polymerization experiments according to the following procedure.

Into a 4 liters stainless steel autoclave, degassed under N₂ stream at 70° C., 1600 cc of anhydrous hexane, 0.1 g of spherical catalyst and 0.5 g of triethylaluminum (Tea) were introduced. The whole was stirred, heated to 85° C. and thereafter 9 bar of H₂ and 3 bar of C₂H₄ were fed. The polymerization lasted 2 hours feeding ethylene to keep the pressure constant. At the end, the reactor was depressurised and the temperature was dropped to 30° C. The collected polymer was dried at 70° C. under a nitrogen flow.

The obtained resulted are reported in Table 2.

TABLE 2
Polymerization results

| Support | Catalyst | | | | | | |
|---|---|---|---|---|---|---|---|
| Prepared as | Prepared as | Polym. Test as | | | | | |
| Described in | Described in | Described in | Mileage | MIE | MIP | MIF | BDP |
| Ex.# | Ex.# | Ex.# | g/g | g/10′ | g/10′ | g/10′ | g/cc |
| 1 | 8 | 11 | 4800 | 0.27 | 1.5 | 22.5 | 0.340 |
| | | 12 | 2900 | 39.0 | — | — | 0.387 |
| 1 | 9 | 11 | 9100 | 0.30 | 1.6 | 23.0 | 0.325 |
| | | 12 | 3000 | 64.0 | — | — | 0.394 |
| 2 | 8 | 11 | 9000 | 0.2 | 1.1 | 23.2 | 0.408 |
| | | 12 | 3300 | 43.0 | — | — | 0.345 |
| 2 | 9 | 11 | 10600 | 0.50 | 2.3 | 45.7 | 0.374 |
| | | 12 | 5600 | 48.0 | — | — | 0.276 |
| 3 | 8 | 11 | 4900 | 0.55 | 2.5 | 46.1 | 0.336 |
| | | 12 | 1700 | 55.0 | — | — | 0.329 |
| 3 | 9 | 11 | 7300 | 1.0 | 4.2 | 69.4 | 0.318 |
| | | 12 | 1400 | 111.0 | — | — | 0.332 |
| 4 | 8 | 11 | 8500 | 0.23 | 1.4 | 22.9 | 0.374 |
| | | 12 | 2500 | 53 | — | — | 0.318 |
| 4 | 9 | 11 | 9600 | 0.10 | 0.40 | 7.8 | 0.396 |
| | | 12 | 2400 | 70.0 | — | — | 0.289 |
| 5 | 8 | 11 | 800 | <0.1 | <0.1 | 1.1 | 0.330 |
| | | 12 | 700 | 16.0 | — | — | 0.371 |
| 5 | 9 | 11 | 20600 | <0.1 | 0.36 | 6.8 | 0.382 |
| | | 12 | 3500 | 45.0 | — | — | 0.323 |
| 6 | 8 | 11 | 1500 | <0.1 | <0.1 | 1.0 | 0.396 |
| | | 12 | 1000 | 52.0 | — | — | 0.386 |
| Comp. 8 | 8 | 12 | 5500 | 71.0 | — | — | broken |

1. Solid adducts comprising MgCl₂ and water and optionally an organic hydroxy compound (A) selected from hydrocarbon structures containing at least one hydroxy group, said compounds being present in a molar ratio defined by the following formula MgCl₂.(H₂0)ₙ(A)ₚ wherein n is from 0.6 to 6, p ranges from 0 to 3, said adduct having a porosity (P_{F}), measured by the mercury method and due to pores with radius of at most 1 μm, of at least 0.15 cm³/g with the proviso that when p is 0, (P_{F}) is at least 0.3 cm³/g.

2. The solid adducts according to claim 1 wherein p is 0 and n ranges from 0.7 to 5.

3. The solid adducts according to claim 1 wherein the porosity ranges from 0.35 to 1.5 cm³/g.

4. The solid adducts according to claim 1 wherein p ranges from 0.1 to 2.5 and n ranges from 0.6 to 2.

5. The solid adducts according to claim 1 wherein the porosity ranges from 0.15 to 0.6 cm³/g.

6. The solid adducts according to claim 1 wherein (A) is selected from alcohols of formula R^{II}OH where R^{II} is an alkyl, cycloalkyl or aryl radical having 1-12 carbon atoms.

7. The solid adducts according to claim 6 wherein R^{II} is ethyl.

8. The solid adducts according to claim 1 wherein the ratio n/p is at least 0.4.

9. A catalyst component for the polymerization of olefins obtained by reacting the adducts according to claim 1 with a transition metal compound of one of the groups IV to VI of the Periodic Table of Elements.

10. The catalyst component according to claim 9 wherein the transition metal compound is selected from titanium compounds of formula Ti(OR)ₙX_{y-n} in wherein n is comprised between 0 and y; y is the valence of titanium; X is halogen and R is an alkyl radical having 1-8 carbon atoms.

11. The catalyst component according to claim 1 wherein the amount of titanium atoms is higher than 4.5%.

12. The catalyst component according to claim 1 wherein the “LA” factor is higher than 0.5 where LA is the molar equivalent of anionic species lacking in order to satisfy all the molar equivalents of the cations present in the solid catalyst component which have not been satisfied by the total molar equivalent of the anions present in the solid catalyst component, all of the molar equivalents of anions and cations being referred to the Ti molar amount.

13. A catalyst system comprising the product obtained by reacting the catalyst component according to claim 1 with an organo-Al compound.

14. The catalyst system according to claim 13 wherein the organo-Al compound is selected from a hydrocarbyl compound of the formula AlR_{3-z}X_{z} above, wherein R is a C1-C15 hydrocarbon alkyl or alkenyl radical, X is halogen and z is a number 0≦z≦3.

15. A process for the polymerization of olefins carried out in the presence of the catalyst system according to claim 13.

16. The catalyst system of claim 14 wherein X is chlorine.
